(19) United States
(12) Patent Application Publication
(10) Pub. No.: US 2017/0155919 A1
(43) Pub. Date: Jun. 1, 2017

(54) DECODING METHOD AND ELECTRONIC APPARATUS

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Qinyong Niu, Tianjin (CN); Shaopeng Yu, Tianjin (CN)

(21) Appl. No.: 15/218,096

(22) Filed: Jul. 25, 2016

Related U.S. Application Data
(63) Continuation of application No. PCT/CN2016/088203, filed on Jul. 1, 2016.

(30) Foreign Application Priority Data
Dec. 1, 2015 (CN) 201510869493.7

(51) Int. Cl. H04N 19/44; H04N 19/157; H04N 19/42; H04N 19/103

(52) U.S. Cl. CPC H04N 19/44; H04N 19/103; H04N 19/157; H04N 19/42

(57) ABSTRACT

Disclosed is a decoding method used for an electronic device, including a decoding step, decodes an audio data stream or video data stream by employing a first decoding manner; and a decoding manner switching step, if the performing the after decoding by employing the first decoding manner fails, it automatically switches to a second decoding manner for performing the decoding. A decoding success rate of the electronic device is improved by automatically switching the decoding manners, and the problem of manually switching the decoding manners is solved.

### CROSS REFERENCE TO RELATED APPLICATIONS

This application is a continuation of International Application No. PCT/CN2016/088203, filed on Jul. 1, 2016, which is based on and claims priority to Chinese Patent Application No. 201510869493.7, filed on Dec. 1, 2015, the entire contents of which are incorporated herein by reference.

### TECHNICAL FIELD

The disclosure relates to a decoding method and an electronic device.

### BACKGROUD

In the prior art, although a player of a browser supports hard decoding and soft decoding, it is required that a user selects a decoding approach when decoding audio or/and video; after the user selects the decoding approach, if the player of a browser fails in decoding by using the decoding approach selected by the user, it is required that the user manually switches the decoding approaches, which results in poor user experience.

Accordingly, there is a need for improving a decoding approach switching method.

### SUMMARY

Based on the above problems, the disclosure provides a decoding method, which makes a user switch decoding approaches by automatically switching a first decoding approach to a second decoding approach, thereby improving the user experience.

On one aspect, the disclosure provides a decoding method, including:

decoding at least one audio data stream or video data stream by using a first decoding approach; and

if the procedure of decoding by using the first decoding approach is unavailable, automatically using a second decoding approach for decoding.

In another aspect, the embodiments of the disclosure further provide a nonvolatile computer storage media having computer executable instructions stored thereon, wherein the computer executable instructions are used to perform any one of the foregoing decoding methods.

On another aspect, some embodiments of the disclosure further provide an electronic device, including: one or more processors; and

a memory; wherein the memory is stored with one or more instructions that can be executed by the one or more processors, the instructions are configured to execute any one of the foregoing decoding methods of the disclosure.

By employing the above technical solution, there are advantages and effects set forth below:

the electronic device decodes the audio data stream or video data stream by employing the first decoding approach, and when the electronic device fails in performing the decoding by employing the first decoding approach, it automatically switches to the second decoding approach for performing the decoding, such that after the electronic device fails in performing the decoding by employing the first decoding approach, the user does not have to manually switch the decoding approaches, and thus the user experience is improved.

### BRIEF DESCRIPTION OF THE DRAWINGS

For a better understanding of the aforementioned embodiments of the invention as well as additional embodiments thereof, reference should be made to the Detailed Description below, in conjunction with the following drawings in which like reference numerals refer to corresponding parts throughout the figures. Apparently, the following description of the drawings are some embodiments of the invention, those of ordinary skill in the art can derive other drawings from these drawings without creative efforts.

FIG. 1 is a flow chart of a decoding method in accordance with one embodiment of the disclosure;

FIG. 2 is a flow chart of a decoding method in accordance with an embodiment of the disclosure;

FIG. 3 is a block diagram of a decoding apparatus in accordance with an embodiment of the disclosure; and

FIG. 4 is a schematic diagram showing an electronic device for decoding an embodiment of the disclosure.

### DETAILED DESCRIPTION

The following will further describe the disclosure in detail in conjunction with the specific embodiments and the accompanying drawings. It is intended to describe the specific embodiments of the disclosure, without any limitation to the disclosure, and a protective scope of the disclosure is defined by the claims.

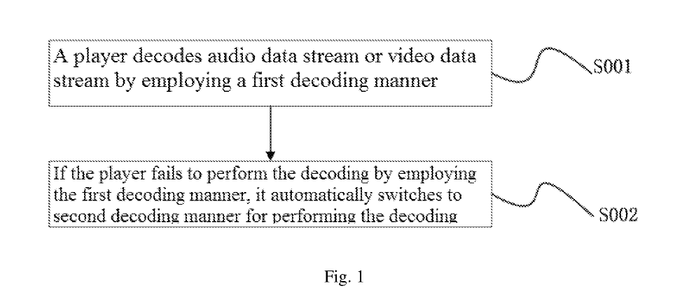

With reference to FIG. 1, the disclosure provides a decoding method, comprising: a decoding step S001, namely, decoding at least one audio data stream or video data stream by using a first decoding approach;

and a decoding approach switching step S002, namely, if the procedure of decoding by using the first decoding approach is unavailable, an electronic device automatically switches to a second decoding approach for decoding. The electronic device may be (or comprise) an independent audio or/and video player, and may also be a player of a browser. An existing audio or/and video player has to decode the audio data stream or/and video data stream before playing the audio data stream or/and video data stream, and plays it after decoding. The audio data stream or video data stream may be directly acquired from a network, and may also be read from an audio or/and video file. The first decoding approach or the second decoding approach may be either soft decoding or hard decoding, and certainly, may be other decoding approach.

The electronic device decodes the audio data stream or/and video data stream by using the first decoding approach, and when the procedure of decoding by using the first decoding approach is unavailable, the electronic device automatically switches to the second decoding approach for decoding, such that after the electronic device fails in performing the decoding by using the first decoding approach, the user does not have to manually switch the decoding approaches, and thus the user experience is improved.

In one of the embodiments, the decoding approach switching step specifically comprises: if performing the decoding by using the first decoding approach fails, detecting whether the electronic device has employed the second decoding approach for performing the decoding or not, switching to the second decoding approach for performing the decoding if the electronic device has not employed the second decoding approach; and performing decoding failure prompt if the electronic device has employed the second decoding approach for performing the decoding. Before switching to the second decoding approach, whether the electronic device has employed the second decoding approach for performing the decoding or not is detected firstly, and the electronic device does not have to switch to the second decoding approach again if having employed this approach, and thus the efficiency is improved.

In one of the embodiments, determining, by a monitoring function, whether the electronic device fails in performing the decoding by using the first decoding approach or not. Setting the monitoring function for the electronic device; and when the monitoring function monitors that the electronic device fails in performing the decoding by using the first decoding approach, detecting whether the electronic device has employed the second decoding approach for performing the decoding or not, switching to the second decoding approach for performing the decoding if the electronic device has not employed the second decoding approach, and performing decoding failure prompt if the electronic device has employed the second decoding approach for performing the decoding. By using a approach of setting the monitoring function for the electronic device, the running efficiency of a system program is improved.

In one of the embodiments, the first decoding approach is of soft decoding, the second decoding approach is of hard decoding; or the first decoding approach is of hard decoding, and the second decoding approach is of soft decoding. When the first decoding approach is of the soft decoding, the second decoding approach is of the hard decoding; and when the first decoding approach is of the hard decoding, the second decoding approach is of the soft decoding. At present, a general electronic device may provide these two decoding approaches; and by switching the two approaches, the decoding success rate of the electronic device is improved.

In one of the embodiments, the first decoding approach is set by the electronic device or set by a user. The first decoding approach may be set to the soft decoding or hard decoding by default by the electronic device, and the benefit of setting the first decoding approach by default by the electronic device is that the user experience is improved since no manual selection of the user is required. The benefit of setting the decoding approach by the user is that the user knowing the performance of the electronic device may rapidly select a proper decoding approach.

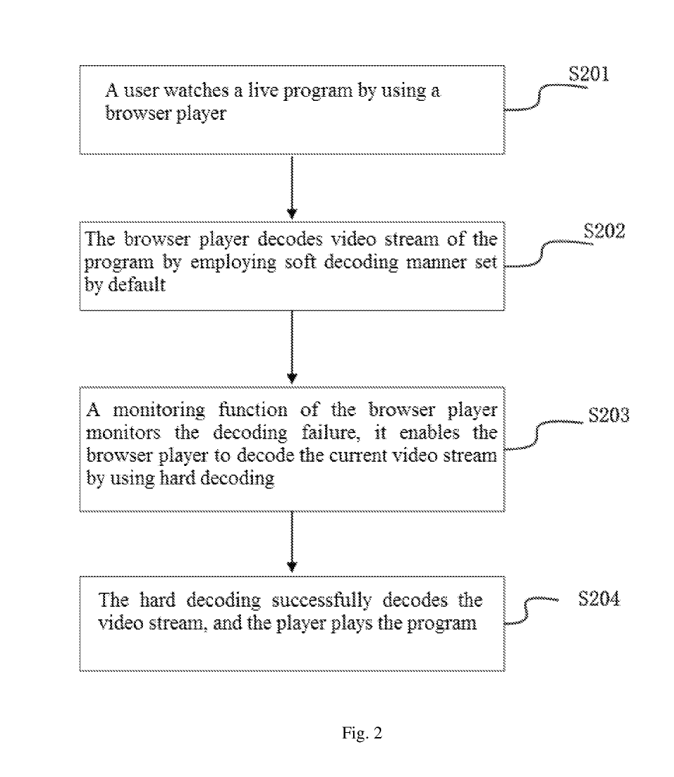

With reference to FIG. 2, which shows an embodiment of the disclosure, the user experience is improved by automatically switching the decoding approaches. It will be described, for example, by taking a browser electronic device as an electronic device, soft decoding as a first decoding approach and hard decoding as a second decoding approach. S201: A user watches a live program by using the browser electronic device; S202: The browser electronic device decodes a video stream of the program by using a soft decoding approach set by default; S203: A monitoring function of the browser electronic device monitors the decoding failure, and the monitoring function enables the browser electronic device to decode the current video stream by using the hard decoding; and S204: The hard decoding successfully decodes the video stream, and the electronic device plays the program.

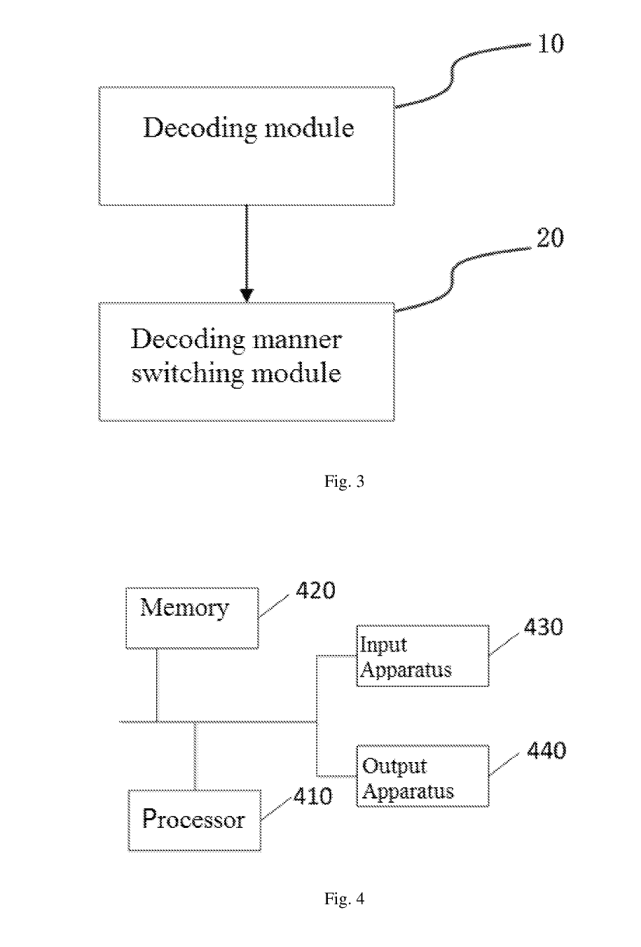

With reference to FIG. 3, the disclosure provides a decoding apparatus, including: a decoding module 10, which is configured to decode an audio data stream or video data stream by using the first decoding approach; a decoding approach switching module 20, which is configured to, if performing the decoding by using the first decoding approach fails, automatically switch to a second decoding approach for performing the decoding.

In one of the embodiments, the decoding approach switching module 20 is specifically configured to: if performing the decoding by using the first decoding approach fails, detect whether the second decoding approach has been employed for performing the decoding or not, switch to the second decoding approach for performing the decoding if the second decoding approach has not been employed, and performing decoding failure prompt if the second decoding approach has been employed for performing the decoding.

In one of the embodiments, determining, by using a monitoring function, whether the electronic device fails in performing the decoding by using the first decoding approach or not.

In one of the embodiments, the first decoding approach is of soft decoding, the second decoding approach is of hard decoding; or the first decoding approach is of hard decoding, and the second decoding approach is of soft decoding.

In one of the embodiments, the first decoding approach is set by the electronic device or set by a user.

An embodiment of the disclosure provides a nonvolatile computer storage media having computer executable instructions stored thereon, wherein the computer executable instructions can perform any one of the decoding methods in the foregoing embodiments of methods.

FIG. 4 is a schematic diagram of hardware configuration of a device of a decoding method provided in the embodiments of the disclosure, as shown in FIG. 4, this device includes:

one or more processors 410 and a memory 420, in FIG. 4, one memory 410 is employed as an example.

The device for executing decoding method may further comprise: an input apparatus 430 and an output apparatus 440.

The processor 410, the memory 420, the input apparatus 430 and the output apparatus 440 may be connected via a bus or other means, and in FIG. 4 connection via a bus is taken as an example.

As a nonvolatile computer readable storage media, the memory 420 can be used to store nonvolatile software program, nonvolatile computer executable program and module, such as the program instructions/modules corresponding to the decoding method in the embodiments of the disclosure (e.g., decoding module 10 and the decoding approach switching module 20 as shown in FIG. 3). The processor 410 executes various functions and applications of a server and data processing by running a nonvolatile software program, an instruction and a module stored in the memory 420, so as to carry out the decoding method in the embodiments of method.

The memory 420 may include a program storage area and a data storage area, wherein the program storage area can store an operating system, application program required for at least one function; the data storage area can store the data created based on the use of decoding device, or the like. Further, the memory 420 may include high-speed random access memory, and may further include nonvolatile memory, such as at least one disk storage device, flash memory device, or other nonvolatile solid-state memory device. In some embodiments, the memory 420 optionally includes a memory remotely located with respect to the processor 410, which may be connected to a decoding apparatus via a network. Examples of such network include, but not limited to, Internet, Intranet, local area network (LAN), mobile communication network, and combinations thereof.

The input apparatus 430 may receive the input numbers or characters information, as well as key signal input associated with user settings of decoding device and function control. The output apparatus 440 may include a display screen or other display device.

The one or more modules are stored in the memory 420, and when being executed by the one or more processors 410, execute the decoding method according to the above embodiments of method.

The above mentioned products can perform the method provided by the embodiments of the disclosure, and they have the function modules and beneficial effects corresponding to this method. With respect to the technical details that are not detailed in this embodiment, please refer to the methods provided by the embodiments of the present disclosure.

The electronic device according to the embodiments of the present disclosure may have many forms, for example, including, but not limited to:

(1) mobile communication device: the characteristic of such device is: it has the function of mobile communication, and takes providing voice and data communications as the main target. Such type of electronic device includes: smart phones, multimedia phones, feature phones and low-end mobile phones.

(2) ultra mobile PC device: this type of device belongs to the category of personal computer, it has the capabilities of computing and processing, and generally has the feature of mobile Internet access. Such type of electronic device includes: PDA, MID and UMPC devices.

(3) portable entertainment device: this type of device can display and play multimedia content. Such type of device includes: audio players, video players, handheld game consoles, e-books, as well as smart toys and portable vehicle navigation devices.

(4) server: this device provides computing services, and the structure of the server includes: a processor, a hard disk, a memory, a system bus and the like, its construction is similar to a general computer, but there is higher requirement on the processing capability, stability, reliability, security, scalability, manageability and other aspects of the server.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that: the above embodiments are merely provided for describing the technical solutions of the present invention, but not intended to limit thereto; although the present invention has been described in detail with reference to the foregoing embodiments, those skilled in the art will appreciate: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

1. A decoding method applied to an electronic device, comprising:
decoding at least one audio data stream or video data stream by using a first decoding approach; and
if the procedure of decoding by using the first decoding approach is unavailable, automatically using a second decoding approach for decoding.

2. The decoding method according to claim 1, wherein the procedure of using the second decoding comprises:
detecting whether the second decoding approach has been used for decoding, switching to the second decoding approach for decoding if the second decoding approach not been employed, and prompting decoding failure information if the second decoding approach has already been employed for decoding.

3. The decoding method according to claim 1, wherein
determining, by using a monitoring function, whether the procedure of decoding by using the first decoding approach is unavailable.

4. The decoding method according to claim 1, wherein
the first decoding approach is soft decoding, the second decoding approach is hard decoding; or the first decoding approach is hard decoding, and the second decoding approach is soft decoding.

5. The decoding method according to claim 1, wherein
the first decoding approach is set by the electronic device or a user.

6. A nonvolatile computer storage media, which has computer executable instructions stored thereon, wherein the computer executable instructions are configured to:
decoding instructions, decoding at least one audio data stream or video data stream by using a first decoding approach; and
decoding manner switching instructions, if the procedure of decoding by using the first decoding approach is unavailable, automatically using a second decoding approach for decoding.

7. The nonvolatile computer storage media according to claim 6, wherein the procedure of using the second decoding comprises:
detecting whether the second decoding approach has been used for decoding, switching to the second decoding approach for decoding if the second decoding approach has not been employed yet, and prompting decoding failure information if the second decoding approach has already been employed for decoding.

8. The nonvolatile computer storage media according to claim 6, wherein
determining, by using a monitoring function, whether the procedure of decoding by using the first decoding approach is unavailable.

9. The nonvolatile computer storage media according to claim 6, wherein
the first decoding approach is soft decoding, the second decoding approach is hard decoding; or the first decoding approach is hard decoding, and the second decoding approach is soft decoding.

10. The nonvolatile computer storage media according to claim 6, wherein the first decoding approach is set by the electronic device or a user.

11. An electronic device, comprising:
one or more processors; and
a memory; wherein the memory is stored with instructions executable by the one or more processors, the instructions are configured to execute:
decoding instructions, decoding at least one audio data stream or video data stream by using a first decoding approach; and
if the procedure of decoding by using the first decoding approach is unavailable, automatically using a second decoding approach for decoding.

12. The electronic device according to claim 11, wherein the procedure of using the second decoding comprises:
detecting whether the second decoding approach has been used for decoding, switching to the second decoding approach for decoding if the second decoding approach has not been employed yet, and prompting decoding failure information if the second decoding approach has already been employed for decoding.

13. The electronic device according to claim 11, wherein
determining, by using a monitoring function, whether the procedure of decoding by using the first decoding approach is unavailable.

14. The electronic device according to claim 11, wherein
the first decoding approach is soft decoding, the second decoding approach is hard decoding; or the first decoding approach is hard decoding, and the second decoding approach is soft decoding.

15. The electronic device according to claim 11, wherein the first decoding approach is set by the electronic device or a user.
